(19) United States
(12) Patent Application Publication
(10) Pub. No.: US 2016/0318262 A1
(43) Pub. Date: Nov. 3, 2016

(54) PROCESS FOR PRODUCING A PLASTIC PART HAVING A FOAM CORE

(71) Applicant: COMPAGNIE PLASTIC OMNIUM, Lyon (FR)

(72) Inventors: Jean-Francois PRAT, Villeurbanne (FR); Denis GILLE, La Pesse (FR); Richard HERAULT, Genas (FR)

(73) Assignee: Compagnie Plastic Omnium, Lyon (FR)

(21) Appl. No.: 15/107,949

(22) PCT Filed: Dec. 23, 2014
(86) PCT No.: PCT/FR2014/053523

§ 371 Date: Jun. 24, 2016

(30) Foreign Application Priority Data
Dec. 26, 2013 (FR) 1363576

(51) Int. Cl. B29C 70/46; B29B 11/06; B29C 43/52; B29C 43/18

(52) U.S. Cl. CPC B29C 70/46; B29C 43/18; B29B 11/06; B29C 43/52; B29K 2105/04

(57) ABSTRACT

Method for producing a plastic part having a sandwich structure, wherein: at least two fibre-reinforced plastic sheets are positioned in a mould; at least one foam insert is positioned in the mould between the plastic sheets, the foam insert forming a structural core; the mould is closed, and pressure and temperature chosen to enable the plastic to flow and polymerise are applied; and the part thus obtained is removed from the mould.

The invention relates to the technical field of methods for manufacturing plastic parts. In particular, the invention relates to a method for producing a plastic part having a sandwich structure with a foam core.

In the automotive field, for example, numerous parts must combine mechanical strength and low weight. To do this, it is known that steel parts can be replaced by plastic parts.

Various methods for moulding plastic parts are known:
compression (thermosetting materials such as SMC);
thermoforming (compression with a thermoplastic material);
injection (for thermoplastic materials).
resin transfer method (RTM)

It is known to use reinforced (thermosetting or thermoplastic) plastic materials. These materials are composed of reinforcement fibres mixed with a polymer resin. These reinforcements include glass or carbon fibres for example. These fibres may be cut (strands of fibre less than 50 mm long), or continuous.

To improve the mechanical performance of some parts, it is known to use hollow bodies. These hollow bodies consist of an upper skin made of loaded plastic, such as an SMC flank, and a lower skin made of loaded plastic, such as an SMC flank.

It is also known to reinforce this structure by separating the two skins with a foam core. The sandwich structure of SMC improves the product rigidity compared with conventional SMC components.

These foamed hollow bodies can be used, for example, to create a vehicle floor. Various methods are known to produce a plastic part having a sandwich structure with a foam core.

A first method consists in introducing a foam core between two SMC flanks:
The first skin is moulded;
The second skin is moulded;
A foam core is inserted between the two skins; and
The two skins are assembled by bonding or riveting.

A second method, called OSS-SMC (One Step Sandwich SMC), can be used to produce light parts in a single manufacturing step. The method comprises the following steps:
An SMC layer containing a foaming agent, inserted between two SMC skins, is positioned in a mould.
The mould is closed, causing the SMC resin to flow, then the upper and lower SMC skins are cured, foaming then occurs at the same time as the curing;
Lastly, the foamed core is cured (reticulation);
The mould is opened, causing expansion of the SMC core containing a foaming agent;

The main advantage of this OSS-SMC method is that it reduces the number of steps in the production process (hence the name “One step process”).

However, this method requires a specific formulation of the SMC containing the foaming agent, depending on the type of SMC used to produce the skins.

Furthermore, it is difficult to supply heat inside the SMC containing the foaming agent.

The density of the foam thus obtained, forming the core of the sandwich structure, is about 1.0 g/cm³. However, to make the part even lighter for example, it is often necessary to use foams of lower density.

Depending on the structural constraints of the part, the foam sometimes needs to be thick. However, this is obtained slowly, by expansion, resulting in long cycle times (180 s-360 s).

Lastly, management of the part edges is difficult. At the edge, in fact, the skin is reticulated when the foamed SMC expands, resulting in a risk of creating cracks in the upper and lower skins.

The invention aims to remedy these disadvantages by providing a method for producing a plastic part having a sandwich structure with a foam core. The method mainly comprises the following steps:
at least two fibre-reinforced plastic sheets are positioned in a mould;
at least one foam insert is positioned in the mould between the plastic sheets, the foam insert forming a structural core;
the mould is closed, and pressure and temperature chosen to enable the plastic to flow and polymerise are applied; and
the part thus obtained is removed from the mould.

This method produces a plastic part having a sandwich structure with a foam core, using any type of foam, and in particular low density foams (less than 1.0 g/cm³). In particular, no additional assembly step is required to create the cohesion between the two skins of the sandwich structure.

Furthermore, this method can be used to produce parts offering an excellent mechanical performance/weight ratio.

Lastly, when the resin flows, it enters the cells of the foam, thereby favouring the cohesion of the sandwich layers. Consequently, there is no need to use chemical cohesion, and chemically incompatible materials can therefore be used.

According to a first embodiment, the plastic can continue its maturing by polymerisation at a pressure P, and a foam whose density is such that at pressure P it undergoes virtually no deformation is used, the foam having a compressibility plateau on its compressibility curve starting at a pressure greater than pressure P.

The pressure P can be less than 30 MPa and the foam density less than 0.2 g/cm3, or the pressure P can be greater than 40 MPa and the foam density greater than 0.4 g/cm3.

According to a second embodiment, the plastic can continue its maturing by polymerisation at a pressure P, and a foam whose compressibility curve has a compressibility plateau for a range of pressures including pressure P is used.

The mould can therefore be dimensioned to take into account a variation in the thickness of the foam insert once the mould is opened.

According to a third embodiment, the plastic can continue its maturing by polymerisation at a pressure P, and a foam whose compressibility curve has a compressibility plateau for a range of pressures less than pressure P is used.

According to the invention, the foam insert can be heated before it is introduced in the mould, or the foam insert can be introduced in the mould at a temperature less than or equal to ambient temperature.

The foam insert can be preformed before it is introduced in the mould.

Lastly, according to the invention, the reinforced plastic sheet can be made of a thermoplastic or thermosetting resin impregnating the reinforcement fibres.

The invention will be better understood on reading the accompanying figures, which are given solely by way of example and not limiting in any way, in which:

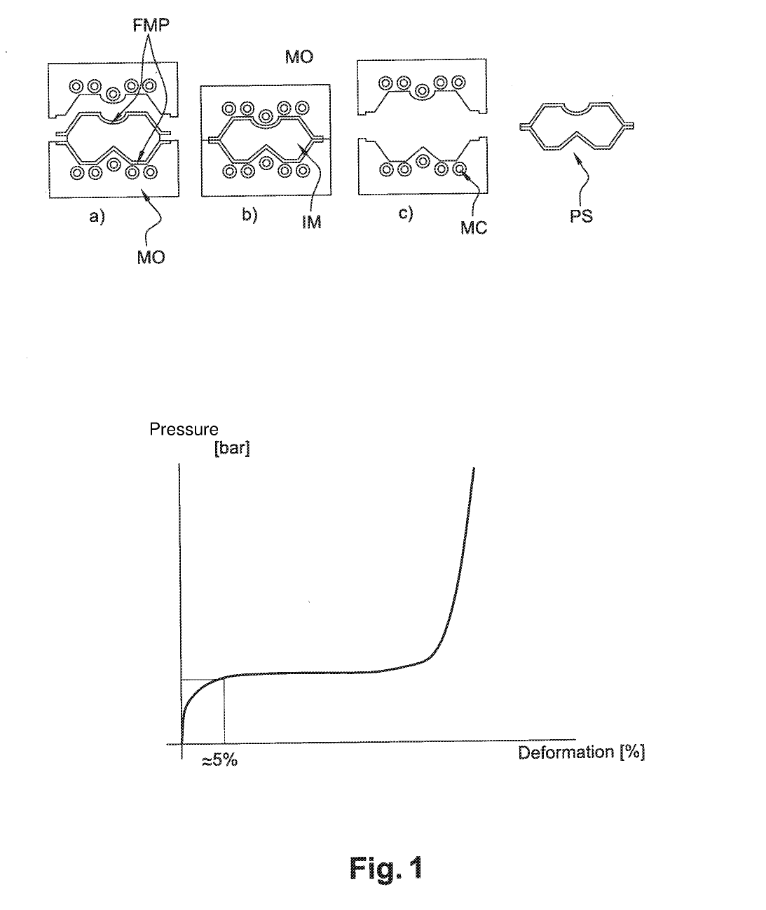

FIG. 1 shows at the top the three steps (a) to c)) of a first embodiment (from left to right), as well as the finished product (a hollow foamed body) on the right, and at the bottom, a diagram of the compressibility curve of the foam used for this method.

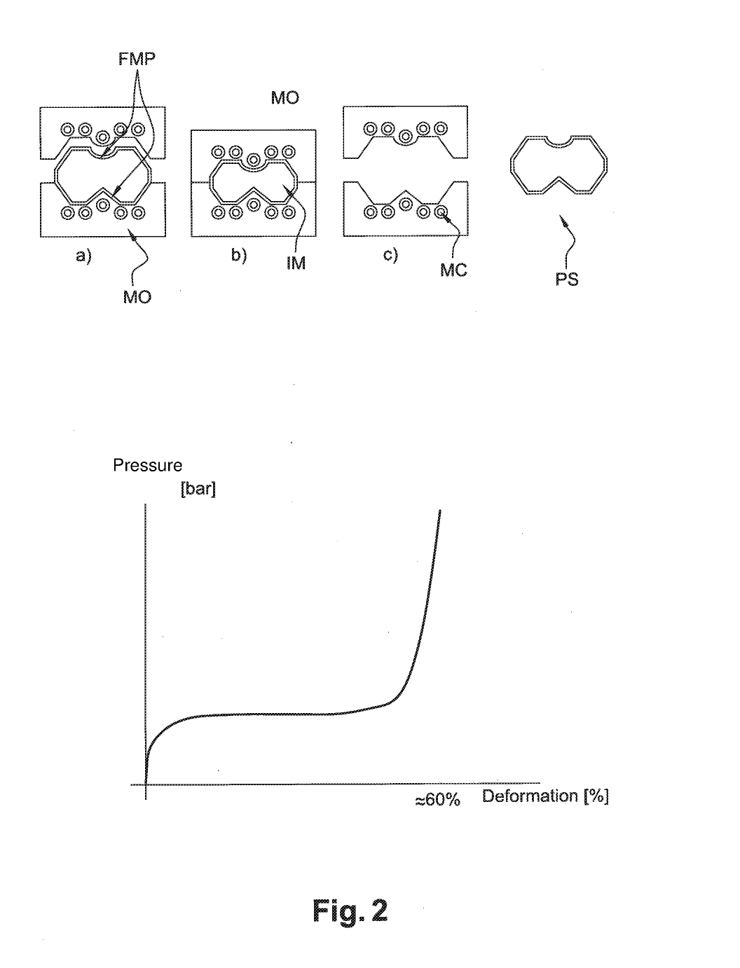

FIG. 2 shows at the top the three steps (a) to c)) of a second embodiment (from left to right), as well as the finished product (a hollow foamed body) on the right, and at the bottom, a diagram of the compressibility curve of the foam used for this method.

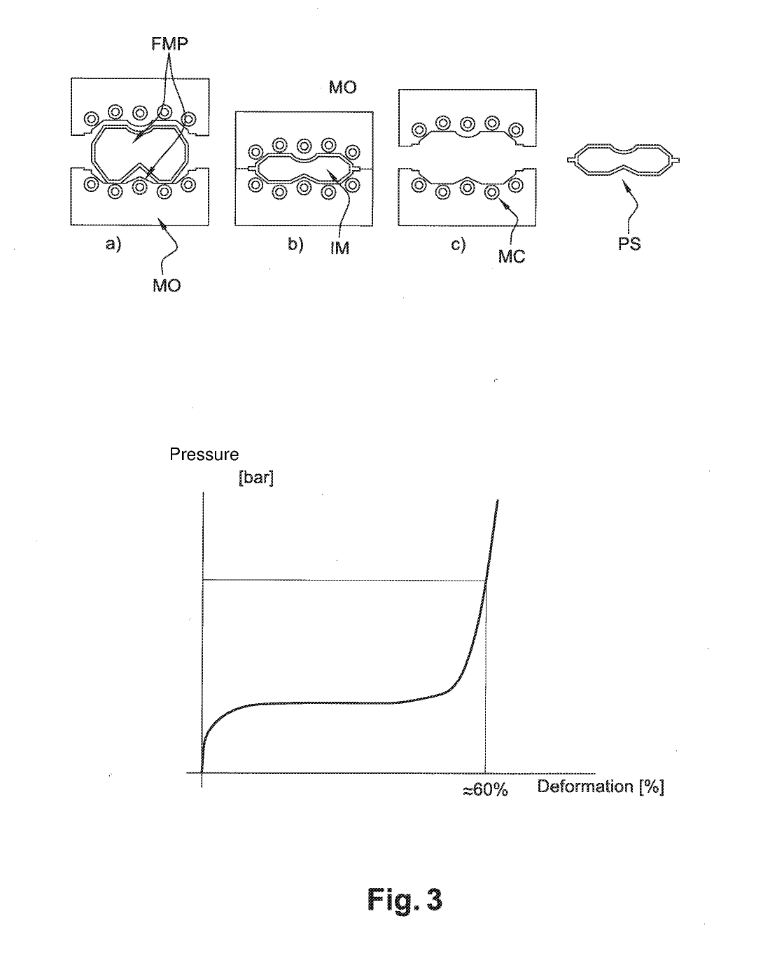

FIG. 3 shows at the top the three steps (a) to c)) of a third embodiment (from left to right), as well as the finished product (a hollow foamed body) on the right, and at the bottom, a diagram of the compressibility curve of the foam used for this method.

### DETAILED DESCRIPTION OF THE INVENTION

We now refer to FIG. 1 which illustrates the method according to the invention for producing a plastic part having a sandwich structure (PS). The method mainly comprises the following steps:
at least two fibre-reinforced plastic sheets (FMP) are positioned in a mould (MO);
at least one foam insert (IM) is positioned in the mould (MO) between the plastic sheets (FMP), the foam insert (IM) forming a structural core;
the mould (MO) is closed, and pressure and temperature (using the heating means MC) chosen to enable the plastic to flow and polymerise are applied; and
the part (PS) thus obtained is removed from the mould.

On FIGS. 1 to 3, step a) illustrates the positioning of the fibre-reinforced plastic sheets (FMP) and the foam insert (IM) in the mould (MO); step b) illustrates compression and curing, when the mould is closed; step c) illustrates opening of the mould and removal of the part from the mould.

The invention is described according to a special embodiment in which the fibre-reinforced plastic sheets (FMP) are SMC (Sheet Moulding Compound) flanks. SMC prepregs are semi-finished products consisting of a resin, called a matrix, impregnating a reinforcement (glass fibre, carbon fibre, aramid fibres, etc.) to which various additives can be added. These prepregs are mainly used for thermosetting organic-matrix composites. SMCs are delivered in sheets or rolls. This prepreg semi-finished product is malleable and not sticky. They finish their polymerisation during moulding.

However, the use of this material is not limiting in any way, and any other fibre-reinforced plastics could be used. Thus, the reinforced plastic sheet can be made of a thermoplastic or thermosetting resin impregnating reinforcement fibres.

The foam core is obtained in a preliminary step.

The reaction force of the compressed foam provides the pressure required to ensure good conversion of the plastic (SMC). The reaction pressure of the foam is the pressure that the foam can transmit to the plastic sheets.

Conversion of the SMC, i.e. its hardening by polymerisation (reticulation) is carried out at a pressure called the conversion pressure. It is therefore the pressure at which the plastic can continue its maturing by polymerisation. This pressure is a specificity, inherent to SMC. It depends on the chemical reaction occurring in the resin, and therefore the resin formulation and the type of load.

Preferably, the shape of the structural foam core (IM) is close to the final geometry of the part. It can therefore be preformed before being introduced in the mould.

According to one embodiment, the foam insert (IM) is inserted in the mould (MO) at a temperature less than or equal to ambient temperature. This increases the reaction pressure during compression (heat of reaction/slow heat exchange with the foam).

According to another embodiment, the foam insert (IM) is heated before being inserted in the mould (MO). This irreversibly deforms the form insert (IM) by thermoforming during compression of the mould. Furthermore, this may favour the SMC reticulation reaction, when the reaction pressure of the foam at this temperature is sufficient to ensure good conversion of the plastic.

To produce a plastic part (PS) having a sandwich structure, of given performance, a compromise must be made between various parameters:
The mechanical strength of the part (mainly bending behaviour and impact resistance);
The dimensions of the part (especially its thickness). Depending on where the part will be used in the vehicle, in fact, the dimensions may be limited; and
The weight of the part.

The mechanical strength of the part is governed mainly by the quality of the fibre-reinforced plastic sheets (FMP). The more they are reinforced, the stronger they are.

However, the higher the reinforcement content, the higher the pressure required to convert the plastic. This pressure, written P, is the pressure at which the plastic can continue its maturing by polymerisation.

For example, for a highly reinforced SMC, with a fibre content greater than 50% by weight for example, the pressure required to convert this SMC is high: about 40 MPa.

For a less-loaded SMC, used on parts requiring less mechanical strength, the pressure generally required for conversion is about 30 MPa.

If a highly reinforced SMC, with therefore a high conversion pressure (40 MPa), is chosen, two types of foam can be chosen. Either a high-density foam is used, and in this case the part will be mechanically strong, thin, but heavy. Or a foam of lower density is used, and in this case the part will be mechanically strong, thicker, but less heavy.

Thus, according to the invention, three variants of the method are considered depending on the constraints to be respected on the finished part:

### Variant 1 (FIG. 1)

The plastic part can continue its maturing by polymerisation at a pressure P.

A foam whose density is such that at pressure P it undergoes virtually no deformation is used, the foam having a compressibility plateau on its compressibility curve starting at a pressure greater than pressure P.

The foam compression curve represents the deformation of the foam (as a % of its volume) against the pressure applied to the foam (in bar). This curve has three sections:
a first section where the foam undergoes virtually no deformation despite the pressure increase applied;
a plateau, i.e. a deformation range for which the pressure applied is constant. In other words, when a certain pressure is reached, the foam continues to deform even if the pressure is not increased.
A foam compressibility wall, i.e. a range of pressures applied for which there is virtually no more deformation.

According to this variant, when the mould (MO) is closed, the foam is compressed until it loses less than 5% of its volume. The foam reaction force compresses the SMC flanks to the pressure required for their correct conversion (hardening by polymerisation). The temperature is provided by the mould walls. When the mould is opened, the reticulated SMC withstands the internal pressure created by the expansion of the foam insert (IM). The initial and final densities of the foam are the same.

According to this variant, if the plastic sheets (FMP) are highly loaded (conversion pressure greater than 40 MPa), then the foam will have a very high density (greater than 0.4 g/cm³, and preferably greater than 0.6 g/cm³), making the part (PS) heavier. However, the part (PS) will have limited dimensions for a high mechanical strength. According to this variant, if the plastic sheets (FMP) are lightly loaded (conversion pressure less than 30 MPa), then the foam may have a low density (less than 0.2g/cm³, and preferably less than 0.05 g/cm³), making the part (PS) lighter. However, the part (PS) will have greater dimensions for a high mechanical strength.

### Variant 2 (FIG. 2)

The plastic part can continue its maturing by polymerisation at a pressure P.

A foam whose compressibility curve has a compressibility plateau for a range of pressures is used, pressure P lying within this range.

According to this variant, when the mould (MO) is closed, the foam is compressed until it loses 60% of its thickness. The foam reaction force compresses the SMC flanks to the pressure required for their correct conversion. The temperature is provided by the mould walls. When the mould is opened, the foam insert returns to its original thickness. The foam insert can be seen on the edge of the part. The initial and final densities of the foam are the same.

During this method, the dimensions of the moulding tools must therefore be controlled to take into account the expansion of the part. The part thickness is in fact an input parameter to be respected. A mould (MO) placing the sandwich structure under greater compression is therefore used, so that once the foam has returned to its original shape, the part has the correct thickness.

The mould (MO) is therefore dimensioned to take into account the variation in the thickness of the foam insert (IM) once the mould is opened.

### Variant 3 (FIG. 3)

The plastic part can continue its maturing by polymerisation at a pressure P.

A foam whose compressibility curve has a compressibility plateau for a range of pressures less than pressure P is used: the optimum SMC conversion pressure is comparable to the pressure of the foam compressibility wall.

According to this variant, when the mould (MO) is closed, the foam is compressed until it loses 60% of its thickness. The SMC flows on the edges of the part to cover the foam insert (IM) completely. When the mould is opened, the SMC is solid enough to withstand the internal pressure created by the expansion of the foam insert. The geometry of the compressed foam insert (IM) must be thin on the edges to minimise this pressure.

According to a special embodiment, the foam insert (IM) is heated before it is introduced in the mould (MO), in order to reduce the residual reaction (i.e. the expansion of the foam once the mould is opened). The density of the foam in the finished part (PS) is higher than the initial density of the foam.

1. Method for producing a plastic part having a sandwich structure, wherein:
at least two fibre-reinforced plastic sheets are positioned in a mould;
at least one foam insert is positioned in the mould between the plastic sheets, the foam insert forming a structural core;
the mould is closed, and pressure and temperature chosen to enable the plastic to flow and polymerise are applied; and
the part thus obtained is removed from the mould.

2. Method according to claim 1, wherein the plastic can continue its maturing by polymerisation at a pressure P, and a foam whose density is such that at pressure P it undergoes virtually no deformation is used, the foam having a compressibility plateau on its compressibility curve starting at a pressure greater than pressure P.

3. Method according to claim 1, wherein the pressure P is less than 30 MPa and the foam density less than 0.2 g/cm3, or the pressure P is greater than 40 MPa and the foam density greater than 0.4 g/cm3.

4. Method according to claim 1, wherein the plastic can continue its maturing by polymerisation at a pressure P, and a foam whose compressibility curve has a compressibility plateau for a range of pressures including pressure P is used.

5. Method according to claim 1, wherein the mould is dimensioned to take into account a variation in the thickness of the foam insert once the mould is opened.

6. Method according to claim 1, wherein the plastic can continue its maturing by polymerisation at a pressure P, and a foam whose compressibility curve has a compressibility plateau for a range of pressures less than pressure P is used.

7. Method according to claim 1, wherein the foam insert is heated before it is introduced in the mould.

8. Method according to claim 1, wherein the foam insert is introduced in the mould at a temperature less than or equal to ambient temperature.

9. Method according to claim 1, wherein the foam insert is preformed before it is introduced in the mould.

10. Method according to claim 1, wherein the reinforced plastic sheet can be made of a thermoplastic or thermosetting resin impregnating the reinforcement fibres.
